(19) United States
(12) Patent Application Publication
(10) Pub. No.: US 2024/0285121 A1
(43) Pub. Date: Aug. 29, 2024

(54) OUTDOOR GRIDDLE STATION WITH GREASE MANAGEMENT SYSTEM

(71) Applicant: Nexgrill Industries, Inc., Chino, CA (US)

(72) Inventors: Wilfrido Barajas, JR., Riverside, CA (US); Sherman Lin, Chino Hills, CA (US); Andre DeBeer, Chino, CA (US)

(73) Assignee: Nexgrill Industries, Inc., Chino, CA (US)

(21) Appl. No.: 18/629,653

(22) Filed: Apr. 8, 2024

Related U.S. Application Data
(63) Continuation-in-part of application No. 17/381,763, filed on Jul. 21, 2021, now Pat. No. 11,980,322.
(60) Provisional application No. 63/054,527, filed on Jul. 21, 2020.

(51) Int. Cl. A47J 37/06; A47J 37/07; F24C 15/14

(52) U.S. Cl. CPC A47J 37/067; A47J 37/0704; A47J 37/0786; F24C 15/14

(57) ABSTRACT

System involved with but not limited to an apparatus including an outdoor griddle station with a system capable of communicating grease and other food byproducts from the cooking surface to a receptacle. A downwardly sloping opening in the cooking surface of the griddle member is disposed in nesting relation to and in fluid communication with a fluid transfer channel situated beneath the griddle member. A fluid transfer channel may pass through the heat source housing of the griddle station, and may comprise a rounded duct or angular chute disposed directly beneath the cooking surface opening. The fluid transfer assembly is disposed over a receptacle capable of holding fluids. The receptacle may be removably supported by a bracket seat attached to the base of the griddle station. In addition, other aspects are described in the claims, drawings, and text forming a part of the present disclosure.

### RELATED APPLICATIONS

This non-provisional application is a continuation-in-part of U.S. application Ser. No. 17/381,763, filed Jul. 21, 2021, which claims the benefit of U.S. Provisional Application No. 63/054,527, filed Jul. 21, 2020. Priority to U.S. application Ser. No. 17/381,763 and U.S. Provisional Application No. 63/054,527 is hereby claimed. U.S. application Ser. No. 17/381,763 and U.S. Provisional Application No. 63/054,527 are hereby incorporated by reference in their entireties.

### TECHNICAL FIELD

Embodiments of the present disclosure relate generally to cooking stations having a griddle intended for outdoor use. More specifically, aspects of the present disclosure relate to grease and food byproduct management methods and systems utilized in conjunction with the griddle and/or cooking station. Further aspects of the present disclosure include providing a griddle station base with various features, such as cabinets, wheels, folding legs, a modular configuration and the like.

### BACKGROUND

Outdoor cooking is a popular tradition in much of the world. Outdoor cooking may be achieved via various modes, but the most common systems utilized for cooking outdoors are barbeque grills, devices which cook food by providing heat in an area below a grill or grate. The heat is often provided via two methods: (1) a gas fuel, such as propane, or (2) a solid fuel such as wood and/or charcoal. Other modes include electrical heating elements. These two types of barbeque grills are generally referred to as “gas grills” or “charcoal grills.”

A griddle is a cooking device that is used in both residential and commercial applications for a range of cooking methods. While griddles gained prominence in the United States in the 20th century as used in commercial establishments such as diners and fast-food restaurants, the use of outdoor griddles was limited. A griddle is commonly a metal plate made of cast or wrought iron, aluminum, or steel. Griddles may be heated by open flame or electrical elements, directly or indirectly. Since a griddle is usually made of a heavy metal, griddles are notoriously difficult to move or otherwise transport. One method utilized in outdoor cooking was to place a small griddle directly on a barbeque grill or over flame burners. However, this method may lead to injury or accident, as there are limited options for controlling or handling a griddle within a barbeque grill.

Cooking on a griddle also produces grease and food byproduct that can accumulate on the solid surface. Some griddles include a drain system to manage the grease, such as a front channel used in commercial griddles at diners or restaurants. A front channel is unsightly and reduces the amount of useable, accessible griddle space for the cook. Front channels also potentially increase the likelihood of grease spillage and build-up over the front side of the cooking station, which may soil a user's clothing. Attaching a collection reservoir to the rear of the griddle can also expose users or passers-by to grease, either by proximity or accidental contact with the reservoir. Furthermore, most or all griddles utilized in residential and commercial settings are open-air cooking surfaces that do not include a lid that covers the entire cooking surface during use. This increases the likelihood that a user's clothes will be soiled by splashing or unanticipated movement of grease or food byproduct during use.

### SUMMARY

It is an object, feature, and/or advantage of the present disclosure to provide an improved outdoor griddle station and methods of use thereof that overcome deficiencies in the prior art. In accordance with one exemplary aspect, a cooking system is provided having a heat source containment structure housing with at least one heating element disposed therein. A griddle member is adapted for placement in overlying relation to the heat source containment structure. The griddle member includes an upper side and underside. The upper side defines a cooking surface wherein heat is transferred from the heating element to the food product via the griddle. This cooking surface here provides a heat transfer zone. At least one drain may extend through the griddle member. The drain may include a proximal opening at the upper side and a distal opening below the upper side, and further includes downwardly extending side walls extending in a convex manner from the proximal opening to the distal opening. A fluid transfer assembly may extend downwardly away from the drain or drains in nested relation and fluid communication with the drain or drains. The fluid transfer assembly may have a basin element and a downwardly extending hollow duct, or a rectangular chute. An exemplary basin element may be oriented in least partial surrounding relation to said downwardly extending sidewalls. A chute may be configured in a straight up-and-down orientation, allowing food byproduct a direct vertical path from the cooking surface or may be vertically curved or angled to allow food byproduct to be conveyed around components disposed in the containment structure or to a receptacle that is either smaller than or off-center from the drain openings in the cooking surface. A receptacle is disposed below the duct or chute and is adapted to receive and hold food byproducts transported through the fluid transfer assembly. The receptacle may have a box configuration including an open top, a floor, a pair of opposing end walls, and a pair of opposing side walls with the end walls and side walls being disposed around the floor.

### BRIEF DESCRIPTION OF THE DRAWINGS

The accompanying drawings, which are incorporated in, and which constitute a part of this specification, illustrate exemplary constructions and procedures in accordance with the present disclosure and, together with the general description of the disclosure given above and the detailed description set forth below, serve to explain the principles of the disclosure wherein:

FIG. 1 is a perspective view of a first embodiment of an outdoor griddle station consistent with the present disclosure including a griddle member;

FIG. 2 is a top view of an exemplary griddle member of the outdoor griddle station in FIG. 1;

FIG. 3 is a bottom view of the exemplary griddle member of FIG. 2;

FIG. 4A is a forward edge view of the exemplary griddle member of FIGS. 2 and 3;

FIG. 4B is a lateral side view of the exemplary griddle member of FIGS. 2 and 3;

FIG. 5 is a perspective view of the exemplary griddle member of FIGS. 2 and 3;

FIG. 6 is a perspective view of an alternative exemplary griddle member featuring multiple drain openings;

FIG. 7 is a perspective view of the optional griddle lid;

FIG. 8 is a perspective view of an exemplary fluid transfer assembly comprising a basin element and hollow duct element;

FIG. 9 is a schematic side view of the fluid transfer assembly illustrated in FIG. 8;

FIG. 10 is a perspective view of the basin element of the fluid transfer assembly in FIG. 9;

FIG. 11 is a perspective view of the hollow duct element of the fluid transfer assembly in FIG. 9;

FIG. 12 is a perspective view of an exemplary grease receptacle assembly;

FIG. 13 is a perspective view of an exemplary bracket seat configured to receive the grease receptacle assembly of FIG. 12;

FIG. 14 is perspective view of an embodiment of an exemplary cooking station with the griddle member removed illustrating exemplary placement of the fluid transfer assembly of FIG. 9 and bracket seat of FIG. 13 for the grease receptacle assembly of FIG. 12;

FIG. 15 is perspective view of an exemplary embodiment of an outdoor griddle station including a hinging lid and cabinet;

FIG. 16A is a perspective view of an embodiment of an exemplary griddle member with two drain openings disposed adjacent to an exemplary splash guard on the right side of the cooking surface;

FIG. 16B is a perspective view of an embodiment of an exemplary griddle member with two pairs of drain openings, with one pair disposed adjacent to an exemplary splash guard on the right side of the cooking surface and a second pair disposed adjacent to an exemplary splash guard on the left side of the cooking surface;

FIG. 17 is a perspective view of an exemplary fluid transfer channel comprising a chute disposed within an exemplary containment structure via a mounting flange extending laterally from the proximal rectangular opening of the chute;

FIG. 18 is a perspective view of an exemplary bracket seat configured to receive a grease receptacle assembly shown FIG. 12 disposed below an opening in the containment structure through which food byproducts may pass;

FIG. 19 is a perspective view of an exemplary containment structure with a rectangular opening disposed in the underside of the containment structure; and

FIG. 20 is a perspective view of an exemplary fluid transfer channel comprising an angled chute with the distal sidewall extending downward in a convex manner.

While constructions consistent with the present disclosure have been illustrated and generally described above and will hereinafter be described in connection with certain potentially preferred embodiments and practices, it is to be understood that in no event is the disclosure limited to such illustrated and described embodiments and practices. On the contrary, it is intended that the present disclosure shall extend to all alternatives and modifications as may embrace the general principles of this disclosure within the full and true spirit and scope thereof. Also, it is to be understood that the phraseology and terminology used herein are for purposes of description only and should not be regarded as limiting. The use herein of terms such as “including” and “comprising” and variations thereof is meant to encompass the items listed thereafter and equivalents thereof as well as additional items and equivalents thereof.

### DETAILED DESCRIPTION

An outdoor griddle station provides advantages over an indoor griddle station in homes where kitchen space is limited. Many foods cooked on griddles produce excess smoke, which many kitchens are ill-equipped to disperse. Providing a grease management system near the back or sides of the station allows the user to use the front of the station closest to them as a cooking surface, reducing the need to reach over a hot griddle to reach cooking food in the back.

An outdoor griddle station including a separate base and griddle member allows for easier cleaning of the griddle member. The griddle member can also be removed from the base to allow for more compact storage. In one embodiment, the base may be composed of a housing for the heating element arranged in a box shape. This heat source containment structure, or firebox, contains one or more heating elements that apply cooking heat to the heat transfer zone of the griddle member, which functions as the cooking surface.

A griddle member with securing members and griddle walls provides a stable cooking surface and prevents grease from spilling off of the cooking surface. The securing members also maintain the griddle member at an elevated distance above the firebox. Additionally, a griddle member with heat deflecting members on its underside prevents the heat from the heating element from escaping out the sides of the griddle member, which directs more heat towards the griddle surface resulting in more efficient heat transfer. This also prevents escaping heat from overheating the user's tools or anything else adjacent to the outdoor griddle station. Further, a griddle member with reinforcing members on its underside prevents the griddle surface from warping due to consistent exposure to high temperatures from the heating element.

The cooking surface of the griddle member may contain one or more drains having a generally inverse frustoconical geometry. That is, the drain or drains may have an opening of greater area at the top than at the bottom with sloping walls extending between the top and bottom openings. One or more generally elliptical drain openings on the griddle member may be used to collect grease from most spatulas and grease pushers. In this regard, it is to be understood that the terms “elliptical” or “ellipse” means any non-circular geometry with a length to width ratio greater than 1 with rounded or pointed ends and curved or straight lateral sides. The ends and lateral sides may be formed by curved surfaces, collections of straight-line segments, or combinations thereof. The curvature of the ends and any curved lateral sides may be either continuous or discontinuous. By way of example only and not limitation, elliptical openings may include a regular oval shape, a polygon having a pair of parallel line segments connected by a convex curve at each pair of ends, a polygon having two pairs of parallel lines arranged in rectangular fashion with convex curves in place of corners, forming a rounded rectangle, and stretched polygonal shapes such as hexagons, octagons and the like using line segments to provide a length to width ratio greater than 1.

When pushed, grease collects along the edge of a spatula or pusher, causing it to spread out. A rounded opening provides a wider hole to catch more grease while sacrificing less cooking area than a circle or square opening with the same width. The opening of the drain and the sloping portion of the cooking surface adjacent to the drain may be substantially elliptical in shape to prevent grease from building up in any corners. In addition, providing a sloped surface adjacent to the grease opening makes grease collection easier by allowing the grease at the edge of the sloped surface to flow downwards into the rounded opening. Instead of pushing all of the grease through the opening, the user only needs to push the grease to the beginning of the sloped surface for it to be directed to a grease receptacle.

The griddle member may include a raised perimeter wall defining a guard extending upwardly from the cooking surface. This guard is intended to protect users and nearby persons from grease splatter caused by boiling grease. In another nonlimiting exemplary embodiment of the griddle member, the entire cooking surface may be configured to slope toward the opening. When the grease is heated by the cooking surface, its viscosity, and therefore its resistance to flow, is lowered, allowing the hot grease to flow across a surface featuring less slope. In this way, the grease may naturally flow downwards toward and into the drain from any part of the cooking surface.

Providing a grease receptacle located within the base of the outdoor griddle station protects the grease tray from being accidentally knocked off of the station by the user or other passerby, reducing the chance of a mess and/or grease burns. The receptacle may be located below the heat source containment structure for case of access. The receptacle may also include laterally-extending support flanges extending from the top of the receptacle. The flanges may rest upon a bracket seat attached to the griddle base to permit the receptacle to be removed and replaced. The receptacle may also include a handle attached to an end wall, which may made of a low thermoconductivity material to prevent the handle from becoming hot to the touch. The receptacle may optionally be made of metal such as aluminum, steel or the like capable of holding hot fluids without warping due to heat.

A fluid transfer channel, shaped similar to a funnel, may be attached via a mounting flange attached to the heat source containment structure below the griddle. The fluid transfer channel maximizes the amount of grease collected from the rounded opening and directs the grease to the receptacle. The top of the fluid transfer channel may be shaped like a basin, with a wider top opening and narrower bottom opening. The narrower bottom opening is operatively connected to a hollow duct. A wider opening of the proximal end of the basin maximizes the amount of grease collected from the rounded opening, while the duct attached to the narrower distal end of the basin element directs the food byproduct directly to the grease receptacle. Both the basin and the hollow duct have heat shielding properties that allow the grease to flow through the channel, which passes through the heat source containment structure where the cooking heat source is located, without catching fire. The basin element of the fluid transfer assembly may be comprised of a metal such as aluminum or ferrous metal that provides modest heat shielding capacity to prevent grease fires. Because the hollow duct passes closer to the heating element, it may need to offer greater heat shielding than the basin element. In order to supply heat shielding, the hollow tube may be composed of a metal or other material with a thickness sufficient to offer heat shielding sufficient to eliminate the potential for a grease fire. The hollow duct may be cylindrical or elliptical in shape in order to minimize the effect of thermal expansion based on the duct's proximity to a heat source. The basin element may have vertical walls at its upper perimeter extending from the wider top opening to allow one or more drains in the griddle member, which protrude downward from the underside of the griddle member, to nest in the basin member without touching the downward-sloping walls of the basin. Such nesting aids in communicating food byproduct from the surface of the griddle to the fluid transfer assembly without spillage. It also allows the griddle member to be removed from the cooking station without a need to remove the grease transfer assembly, facilitating cleaning. By way of example only and not limitation, “fluid transfer assembly” as used throughout the disclosure, refers to a structure capable of receiving fluid and solid food byproduct from an opening disposed in a cooking surface and directly above a fluid transfer assembly and conveying it downward in gravity-assisted fashion to a receptacle, regardless of the number of parts or components which comprise it.

A fluid transfer channel, shaped similar to a chute, may be attached via a mounting flange attached to the heat source containment structure below the griddle. An exemplary fluid transfer channel may comprise a proximal opening configured to receive grease and other food byproduct from a drain opening and a distal opening to direct grease to a receptacle. One or more distal drain openings may be provided in nested relation to the proximal opening of the fluid transfer channel, minimizing grease spillage and preventing the grease transfer channel from having to be fixed to the underside of the griddle. The proximal and distal openings may be rectangular or round in shape, The distal opening may be narrower or smaller than the proximal opening to effectively direct grease to the receptacle disposed below the fluid transfer channel, while a larger proximal opening allows grease to be caught from one or more openings in the cooking surface disposed above without spillage. A chute configuration of a fluid transfer channel also possesses heat shielding properties that allow the grease to flow through the channel, which passes through the heat source containment structure where the cooking heat source is located, without catching fire, and may be comprised of a metal such as aluminum or ferrous metal that provides modest heat shielding capacity to prevent grease fires. In order to supply heat shielding, the chute may be composed of a metal or other material with a thickness sufficient to offer heat shielding sufficient to eliminate the potential for a grease fire. The chute may be configured in a straight up-and-down orientation, allowing for a direct vertical path from the griddle surface to the byproduct receptacle, or the walls of the chute may be vertically curved or angled, forming a bend or arc between the proximal and distal openings. This configuration allows grease to be conveyed from a larger proximal opening to a smaller distal opening. The chute may also comprise an angled configuration, allowing grease to be conveyed to a receptacle that is not centered beneath the proximal opening of the chute. The angle of inclination may vary depending on specific application requirements, with steeper angles facilitating faster grease flow. At the bottom end of the chute, the distal opening may narrow to achieve a funnel-like effect. This narrowing serves multiple purposes: firstly, it concentrates the flow of grease, directing it towards the receptacle. Secondly, it reduces the risk of spillage or splashing during the transfer process, ensuring the cooking station remains clean. The distal opening may be further equipped with features such as a drip edge or lip to contain any residual grease and prevent it from escaping onto surrounding surfaces. The proximal opening may have vertical walls at its upper perimeter extending from the wider top opening to allow one or more drains in the griddle member, which protrude downward from the underside of the griddle member, to nest deeper within the chute without touching the downward-sloping walls of the chute. Such nesting aids in communicating food byproduct from the surface of the griddle to the fluid transfer channel without spillage. In this regard, it is to be understood that the terms “chute” means any channel or slide capable of conveying things or substances from a higher to a lower level, regardless of whether the chute is completely vertical or features a slope down which things or substances may slide.

In accordance with one exemplary practice, including foldable legs on the outdoor griddle station base allows users to transport the griddle via car. With foldable legs, the griddle can fit in the trunk or back seat of most family cars, whereas non-foldable legs would prevent this. The foldable legs also allow it to take up less space in storage. Optionally including wheels on the base station increases the mobility of the outdoor griddle station. This allows the user to move it to and from a storage area, or to move the griddle to allow for more outdoor space, for example to entertain a dinner party. Optionally including cabinets and shelves on the base station increases the user's utility of the outdoor griddle station, allowing them to store things such as spatulas, tongs, and towels, keeping needed tools and implements in a convenient location. Optionally including space for a fuel source increases the user's utility of the outdoor griddle station, allowing the station to occupy less space and allowing a more aesthetically-appealing location to store a fuel tank.

Optionally including space for a fuel source within the outdoor griddle station allows the griddle station to operate absent a direct gas line. This increases the mobility of the station, allowing the user to use it essentially anywhere they can move it provided they have a propane tank. Keeping the fuel source within the station reduces the amount of space the station and fuel source take up, and also reduces the risk of the user or somebody else bumping into the fuel source or line and disconnecting it. Optionally including a connecting mechanism for a fuel source in the outdoor griddle station allows the griddle to be connected to a gas line, eliminating the need of the user to constantly switch propane tanks.

Optionally including a lid on the outdoor griddle station allows the user to store the griddle outside without debris coming into contact with the griddle surface. Additionally, closing the lid while cooking food on the griddle surface increases the internal temperature and cooks the food from both the bottom and the top, resulting in lower cook times. The incorporation of a thermometer, heating/warming rack, and/or utensil holders with the optional lid provide further advantages.

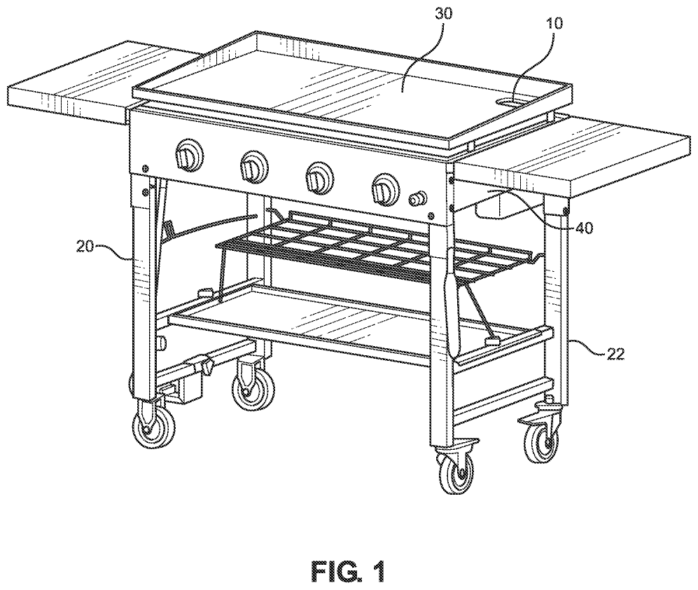

Referring now to the drawing wherein like numerals refer to like parts in the various views, FIG. 1 is a perspective view of an exemplary embodiment of an outdoor griddle station. The illustrated exemplary griddle station includes an elliptical drain opening 10 located near the rear of a griddle member 30. In the illustrated construction, a base 20 includes a heat source containment structure 40 housing at least one heat source therein. Legs 22 may be used to raise the height of the cooking surface.

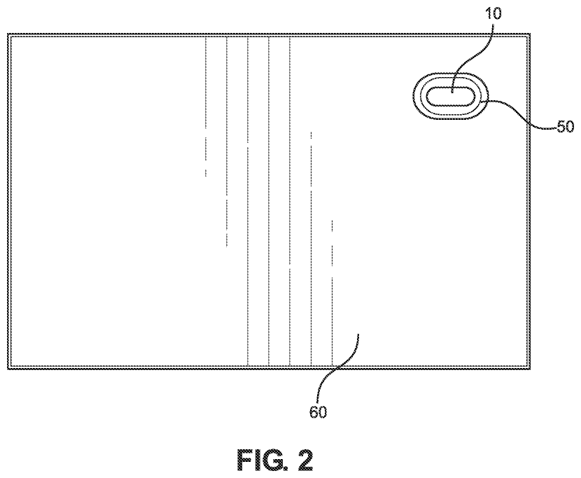

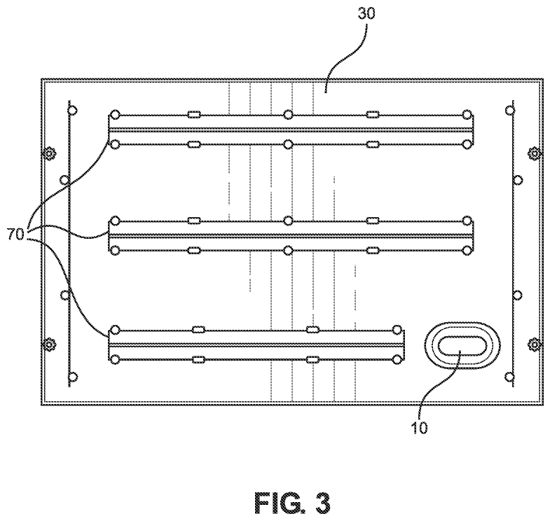

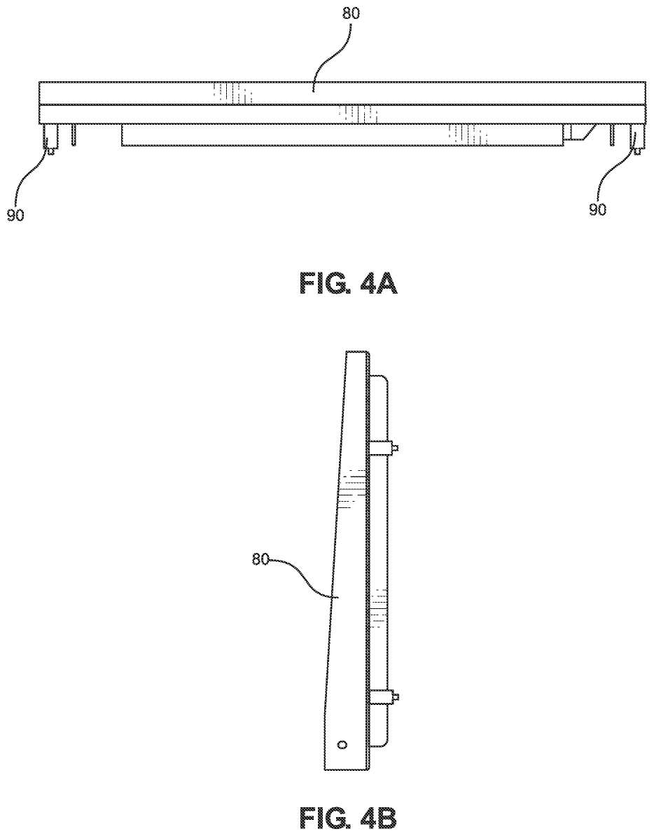

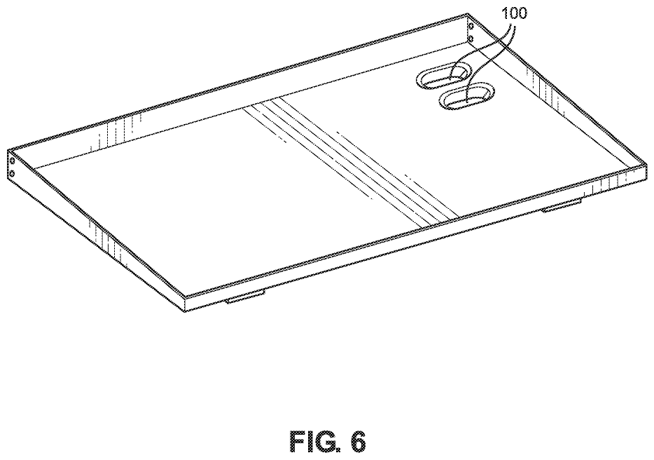

As seen in FIGS. 2, 5 and 6, the griddle member includes a heat transfer zone 60 outboard from the elliptical drain opening 10. As shown, the elliptical drain opening 10 is at least partially surrounded by downwardly extending sloped sidewalls defining a sloped surface 50 extending downwardly from the cooking surface formed by the heat transfer zone 60. The proximal opening at the top of the sloped surface 50 is larger than the distal end of the sloped surface, which terminates at the drain opening 10. As best seen in FIG. 3, reinforcing members 70 may be disposed across the underside of the griddle member 30 to maintain its shape under the stress of high temperatures. As shown in FIG. 6, multiple drain openings 100 may be used if desired.

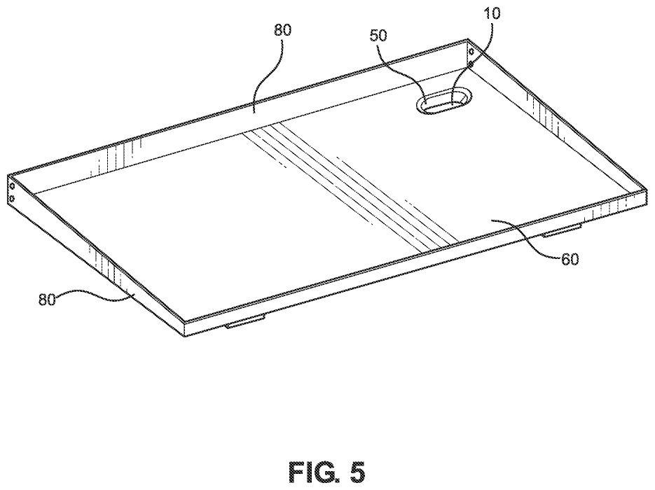

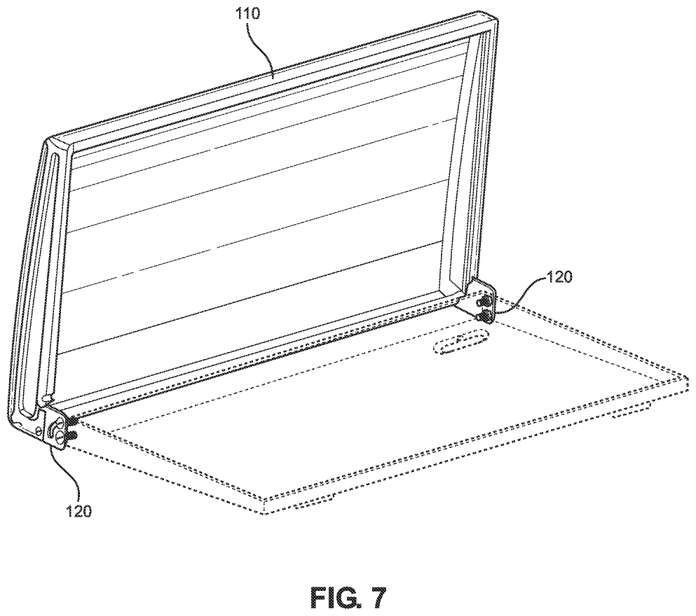

If desired, a hinging griddle lid 110 may be provided (FIG. 7). As shown, in the illustrated exemplary construction hinges 120 may be used to attach the griddle lid to the splatter guard 80 (FIG. 5) and allow the griddle lid 110 to open and close.

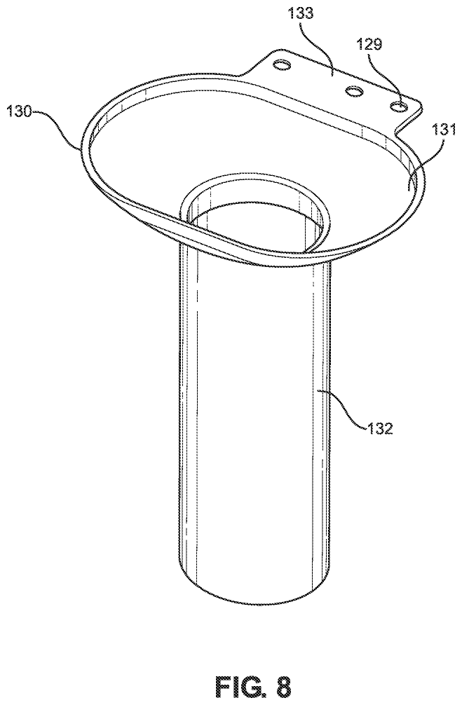

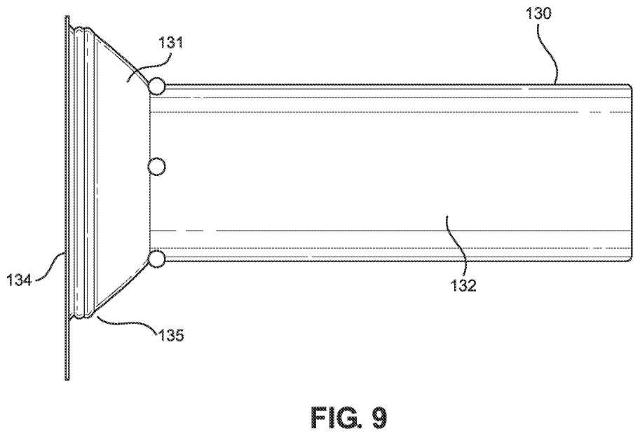

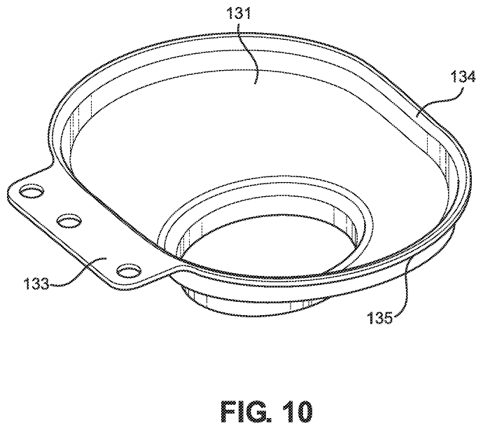

As noted previously, a fluid transfer assembly 130 may be used to capture and convey waste away from the drain opening 10. As illustrated in FIGS. 8 and 9, in one exemplary construction the fluid transfer assembly 130 includes a basin element 131 and attached to a hollow duct 132 defining a downwardly extending stem. A mounting flange 133 extends radially way from the basin element 131 and may be used to attach the fluid transfer assembly 130 to the heat source containment housing 40 using bolts or screws (not shown) through attachment openings 129. As best seen in FIGS. 8 and 9, the mounting flange 133 extends outwardly from the wider proximal opening 134 of the basin element 131. This exemplary embodiment of the basin element 131 also shows vertical perimeter walls 135 extending downward from the proximal opening 134 defined by the free upper edge of the basin element to a sloped annular surface 137. As will be appreciated, the vertical perimeter walls 135 around the proximal opening of the basin element 131 aid in establishing a nesting relation between the downwardly extending sloped surface 50 and the interior of the fluid transfer assembly 130 without abutting the sloped annular surface at the interior of the fluid transfer assembly. That is, vertical perimeter walls 135 may act as a spacer to hold the exterior of the sloped surface 50 of the drain 50 slightly away from sloped annular surface of the basin element.

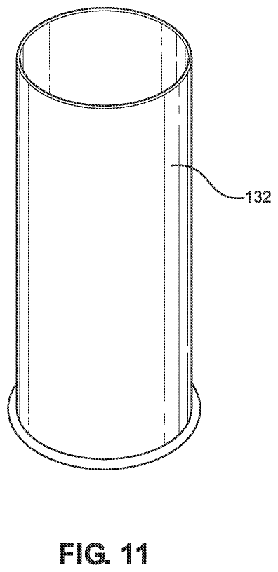

As seen in FIG. 11, the hollow duct 132 of the fluid transfer assembly 130 may be a substantially straight pipe of substantially uniform diameter connected directly to the distal opening of basin element 131 by welding, mechanical attachment, or other suitable technique. However, it is likewise contemplated that the duct 132 may be curved and/or have a variable diameter if desired.

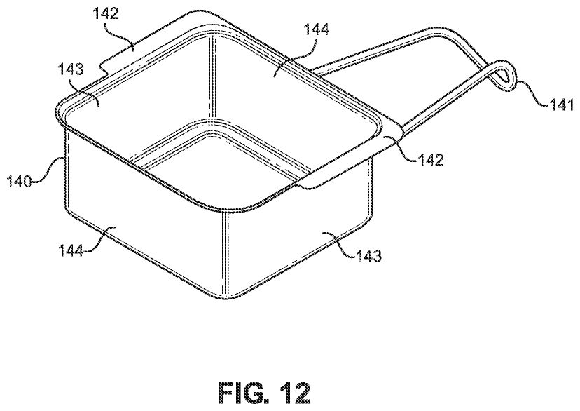

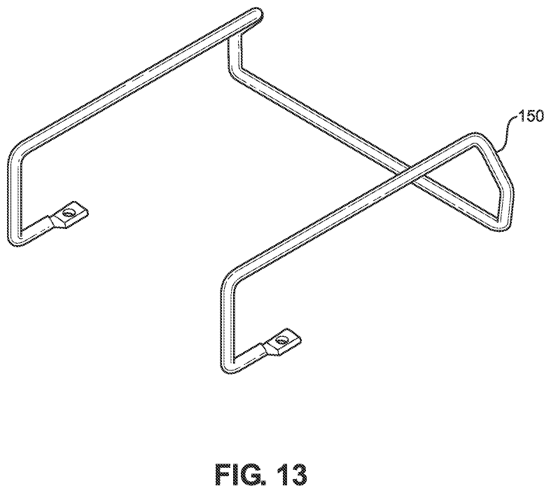

The hollow duct 132 provides fluid connection between basin element 131 and a grease receptacle assembly 140 (FIG. 12). In the illustrated exemplary construction, grease receptacle assembly 140 includes side walls 143 and end walls 144 extending upward to form a box configuration adapted to hold fluid without leaking. Support flanges 142 extend laterally from the top of the side walls 143 that allow the receptacle 140 to be removably supported by a bracket seat 150 (FIG. 13). A handle 141 is attached to one of the end walls 144 to enable the receptacle 140 to be removed from and replaced into the bracket seat 150.

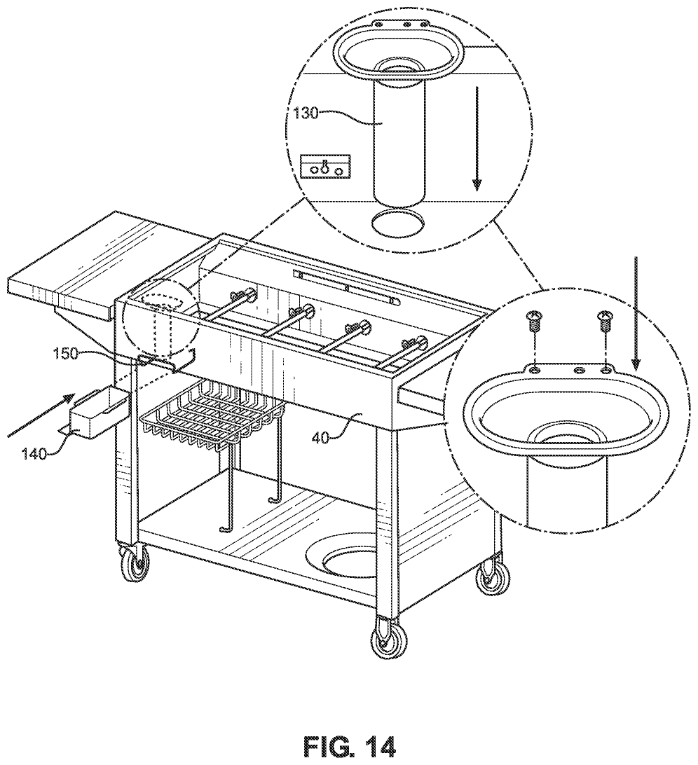

FIG. 14 is a perspective view of an embodiment of the cooking station showing the placement of the fluid transfer assembly 130 from FIG. 8 and bracket seat 150 from FIG. 13 onto the heat source containment structure 40. The receptacle 140 from FIG. 12 may be held in place by the bracket seat 50, which places the receptacle in position to receive grease and other food by products from the cooking surface of the griddle member 30, which passes through the fluid transfer assembly 130.

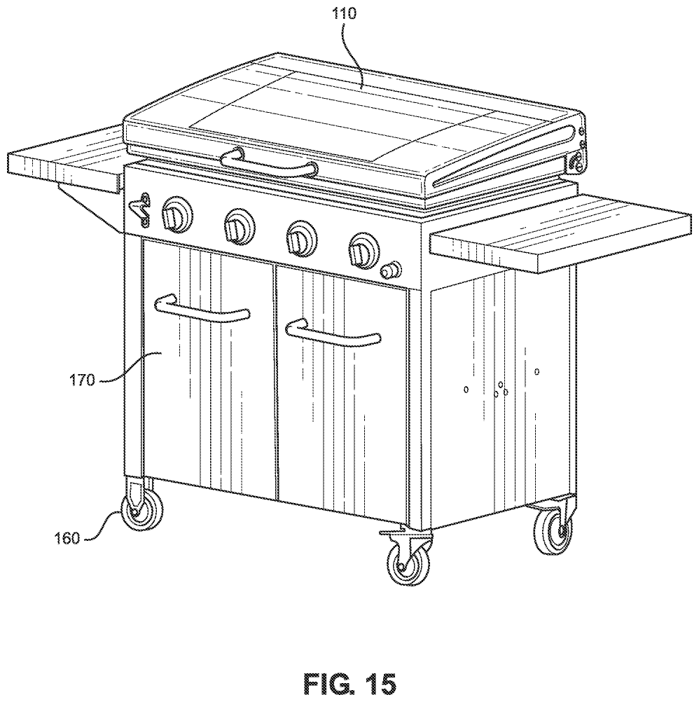

FIG. 15 is a perspective view of an embodiment of an outdoor griddle station including cabinet doors 170 attached to the legs of the griddle base 20 to form an enclosed storage space. Wheels 160 may be attached to the legs of the griddle base 20 to enhance mobility of the griddle station.

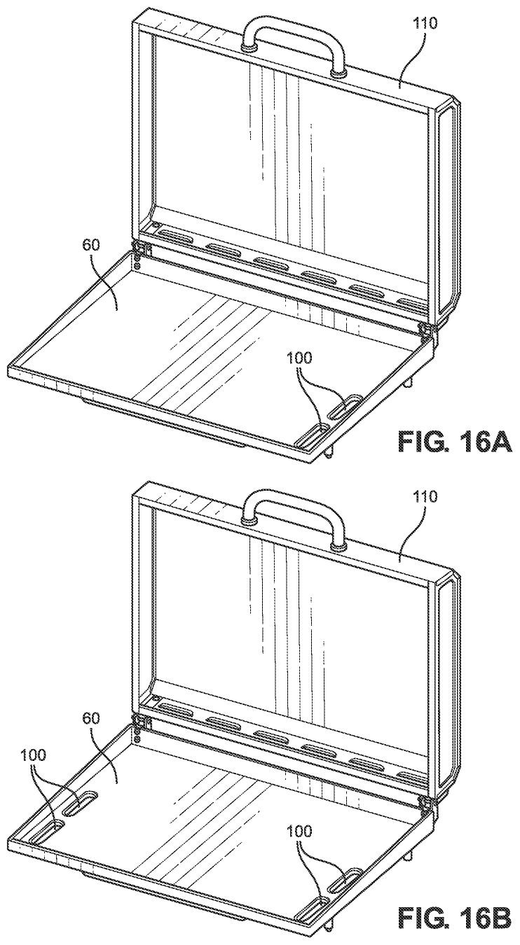

FIG. 16A is a perspective view of a pair of elliptical openings 100 arranged longitudinally and disposed in a cooking surface 60, adjacent to the right-side of the splash guard 80, wherein the openings function as a drain capable of conveying grease to a fluid transfer channels disposed underneath the openings. An exemplary griddle lid 110 is also shown.

FIG. 16B is a perspective view of two pairs of elliptical openings 100, each arranged longitudinally and disposed in a cooking surface 60, adjacent to exemplary left and right sides of the splash guard 80, wherein the openings function as drains capable of conveying grease to fluid transfer channels disposed beneath the openings. An exemplary griddle lid 110 is also shown.

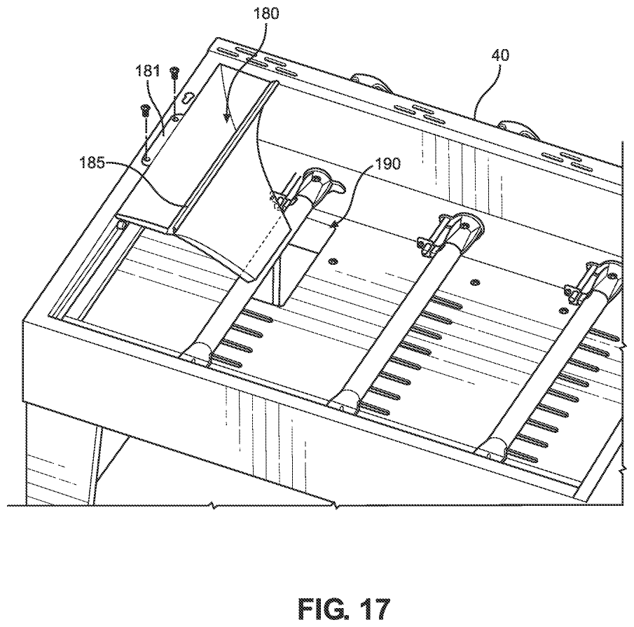

FIG. 17 is a perspective view of an exemplary fluid transfer chute 180 disposed within an exemplary heat source containment housing 40 and mounted to the left side of the housing. An exemplary fluid transfer chute 180 may be fixed to the sidewall of a containment structure via a flange 181 extending laterally from the proximal opening 180 of the chute. In this exemplary embodiment, a pair of screws passing through screw hole openings 182 are utilized to affix the flange 181 of the fluid transfer chute 180 to a vertical side wall of the heat source containment housing 40. A proximal opening 183 features an exemplary vertical wall 185 extending upward from one side of the rectangular perimeter of the proximal opening to allow one or more drains in the griddle member, which protrude downward from the underside of the griddle member, to nest in the top of the chute without touching its downward-sloping walls of the chute. In this embodiment, the chute 180 comprises sidewalls that slope downwardly in a curved fashion and terminate in a rectangular distal opening disposed over a larger rectangular opening 190 disposed in the bottom surface of the containment structure 40. In this exemplary configuration, grease and other food byproducts fall through one or a plurality of openings in the cooking surface into the fluid transfer chute, which conveys the byproducts in gravity-assisted fashion downward, where it falls through an opening 190 in the base of the containment housing 40 and into a removable grease receptacle disposed below said opening 190.

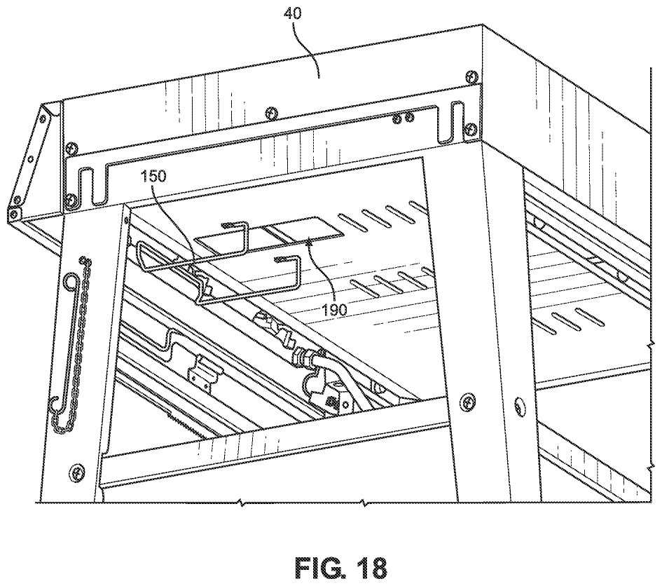

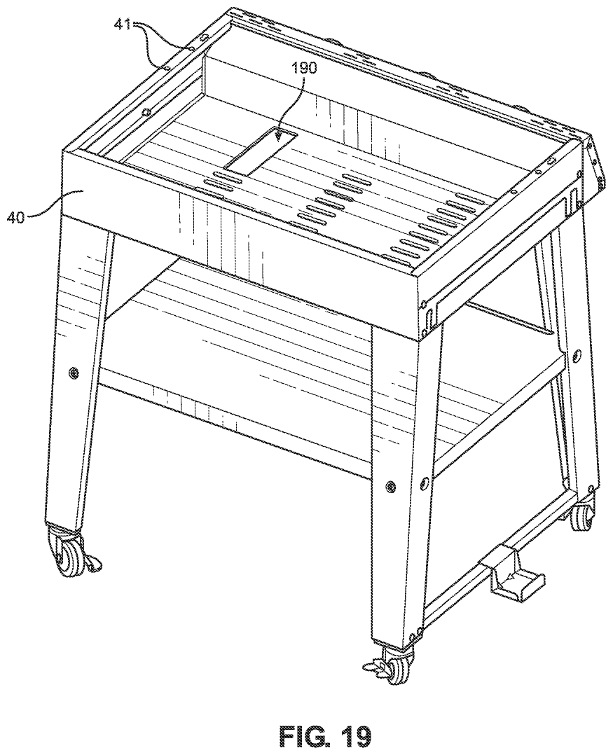

As seen in FIGS. 18 and 19, a rectangular opening 190 may be disposed in the underside of an exemplary containment housing 40. A bracket 150 may be affixed to the underside of the containment housing 40 such that a removably supported receptacle may be held in place to receive grease and food byproducts passing from the cooking surface through a fluid transfer channel. In preferred embodiments, the dimensions of the receptacle extend beyond the dimensions of the distal end of the fluid transfer channel to minimize or eliminate spillage. FIG. 19 also shows an exemplary embodiment of a containment housing 40 with mounting holes 41 for a fastener such as a screw that may be used to affix a fluid transfer channel to the sidewall of the containment housing as shown in FIGS. 14 and 17.

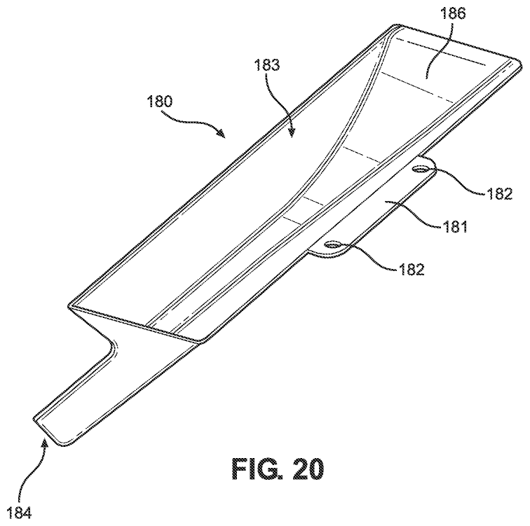

FIG. 20 is a perspective view of an exemplary fluid transfer chute 180 provided in an angled or slanting configuration, in which the distal narrow sidewall 186 extends in downwardly curving or convex fashion from a rectangular perimeter proximal opening 183. As can be seen from the illustration, the fluid transfer chute 180 is configured to convey grease and food byproducts in gravity-assisted fashion to a distal opening 184 at the bottom of the chute. In this configuration, the proximal opening 183 is larger than the distal opening 184, thereby allowing concentration of the flow of grease, and directing it towards the receptacle disposed beneath the distal opening. In a preferred embodiment, the receptacle disposed below the distal opening 184 should have greater dimensions than the distal opening 184 to reduce spillage. An exemplary mounting flange 181 extending laterally from a section of the perimeter of the proximal opening is also shown with openings 182 that may be utilized to mount the exemplary chute 180 to a fixed structure.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the disclosure (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A cooking system comprising:
a heat source containment structure housing at least one heating element disposed therein;
a griddle member adapted for placement in overlying relation to said heat source containment structure, the griddle member including an upper side and underside, the upper side defining a cooking surface comprising a cooking surface and at least one drain extending through said griddle member between said upper side and said underside, said at least one drain having an inverse frustoconical geometry with a proximal opening and a distal opening, wherein said at least one drain includes an elliptical perimeter at the upper side, said drain further including downwardly extending side walls extending in a convex manner from the proximal opening to the distal opening, said griddle member further including a raised perimeter wall defining a splatter guard extending upwardly from the perimeter of the heat transfer zone;
a metal fluid transfer channel extending downwardly away from said drain in nested relation and fluid communication with, directly beneath, and not affixed to said at least one drain, the fluid transfer channel comprising a chute that includes side walls downwardly extending from the proximal opening to the distal opening wherein a side wall includes an interior surface extending continuously from a proximal opening to a distal opening in downwardly convex fashion, the dimensions of said proximal fluid transfer channel opening extending beyond the dimensions of each distal opening of said at least one drain, and said chute including at least one mounting flange configured to affix said fluid transfer channel to a heat source containment structure; and
a metal receptacle disposed below said chute and adapted to receive and hold food byproducts transported through the fluid transfer channel, said receptacle having a box configuration including an open top, a floor, a pair of opposing end walls, and a pair of opposing side walls, said end walls and side walls being disposed around the floor, said receptacle further including a handle attached to an end wall and support flanges extending laterally away from upper edges of said opposing side walls, said support flanges being adapted to support said receptacle in sliding relation to a bracket attached to said heat source containment structure.

2. The cooking system as recited in claim 1, wherein a plurality of support members are affixed to the underside of said griddle member.

3. The cooking system as recited in claim 1, wherein said proximal drain opening has an effective length dimension and width dimension wherein said length dimension is at least 1.5 times the length of said width dimension.

4. The cooking system as recited in claim 1, wherein said fluid transfer channel comprises ferrous metal.

5. The cooking system as recited in claim 1, wherein said one or more drains are disposed adjacent to one end of a cooking surface, further comprising a second fluid transfer channel disposed in nested relation beneath one or more drains at an opposing end of the cooking surface.

6. The cooking system as recited in claim 1, wherein said griddle member includes two elliptical drains arranged in a longitudinal line provided in nested relation with the proximal opening of a fluid transfer channel disposed directly beneath said two elliptical drains.

7. The cooking system as recited in claim 1, wherein said proximal opening of the fluid transfer channel is rectangular in shape.

8. The cooking system as recited in claim 7, wherein the perimeter of said proximal opening of the fluid transfer channel further includes a raised wall extending vertically.

9. The cooking system as recited in claim 7, wherein at least one side of the perimeter of said proximal opening of the fluid transfer channel further includes a raised wall extending vertically.
